(19) United States
(12) Patent Application Publication
(10) Pub. No.: US 2022/0131372 A1
(43) Pub. Date: Apr. 28, 2022

(54) METHOD FOR CHECKING THE BEHAVIOR OF AT LEAST ONE GROUP OF CONSUMERS IN A MOTOR VEHICLE

(71) Applicant: Robert Bosch GmbH, Stuttgart (DE)

(72) Inventors: Yasen Iliev, Sofia (BG); Yavor Nikolov, Sofia (BG); Markus Woerz, Leonberg (DE); Christel Sarfert, Korntal-Muenchingen (DE)

(21) Appl. No.: 17/449,175

(22) Filed: Sep. 28, 2021

(30) Foreign Application Priority Data
Oct. 22, 2020 (DE) 102020213357.3

(51) Int. Cl. H02J 1/14; B60R 16/03; H02M 3/04

(52) U.S. Cl. CPC H02J 1/14; H02M 3/04; B60R 16/03

(57) ABSTRACT

A method for checking the behavior of at least one group of consumers in a motor vehicle. In the method, it is checked whether the at least one group of consumers behaves corresponding to a request to change their consumption, for which purpose the power consumption of the group of consumers is measured and compared to a modeled consumption calculated based on a dynamic model of the at least one group of consumers, at least one algorithm being used for the comparison.

### CROSS REFERENCE

The present application claims the benefit under 35 U.S.C. § 119 of German Patent Application No. DE 102020213357.3 filed on Oct. 22, 2020, which is expressly incorporated herein by reference in its entirety.

### FIELD

The present invention relates to a method for checking the behavior of at least one group of consumers in a motor vehicle, in particular, a motor vehicle including an automated driving function, and to a module for carrying out the method.

### BACKGROUND INFORMATION

In motor vehicles, electrical consumers are typically situated in a vehicle electrical system. In terms of the consumers, a distinction is made in the process between safety-relevant consumers and non-safety-relevant consumers, such as for example quality management (QM) consumers. During operation of the vehicle electrical system, it is important that the power supply for, in particular, the safety-relevant consumers is always ensured. To ensure the safety of the vehicle electrical system, it is conventional to monitor the power supply in the vehicle electrical system, and thus in the motor vehicle.

A method for monitoring the power supply of a motor vehicle including automated driving functions is described in PCT Patent Application No. WO 2019/145087 A1. At least one parameter of the energy store is predicted as a function of a load profile for transferring the vehicle into a safe state, and the associated mode of operation and/or the automated driving functions is/are enabled as a function of the predicted parameter of the energy store. The predicted parameter is ascertained as a function of a base load and/or a shut-off potential of the consumer not needed for the mode of operation.

### SUMMARY

Against this background, a method and a module for carrying out the method are introduced. Specific embodiments of the present invention may be derived from the disclosure herein.

In accordance with an example embodiment of the present invention, the method provides checking the behavior of at least one consumer in a motor vehicle, it being checked whether the at least one consumer behaves corresponding to a request to change its consumption, for which purpose the power consumption of the consumer is measured and compared to a modeled consumption calculated based on a dynamic model of the at least one consumer, at least one algorithm being used for the comparison.

If a degradation of a, in particular, this one, consumer occurs due to the detected power consumption of the entire vehicle electrical system or of an individual consumer, it should thus be checked, for ensuring the reliable operation, whether this consumer, in response to a request, has changed the consumption corresponding to this request. This is addressed by the present invention. In the process, at least one dynamic model of the consumer is used.

The method in accordance with an example embodiment of the present invention makes it possible to increase the reliability and, at the same time, the availability, in particular, of automated driving functions as well as of the required power supply in a simple manner.

A dynamic model is a mathematical or physical model of a device whose behavior is time-dependent, or of a time-dependent process. In the process, the model maps the temporal behavior of at least one consumer, taking its input signals into consideration, and compares this behavior to existing measured variables.

In this way, the ability of a consumer for degradation or shut-off may be checked. For this purpose, for example, a parameter of the consumer prior to and after the request for the degradation or shut-off may be measured and compared. It is thus monitored whether a degraded consumer actually consumes less power corresponding to the specifications in that, in one embodiment, a parameter representing the consumption of the consumer is compared to a parameter prior to the request.

Furthermore, it shall be noted that the request for a change in the consumption may mean that the power consumption is to be reduced, which means a degradation of the consumer, or that the power consumption is to be increased. Moreover, the request may be directed at a shut-off of the consumer, which means that the requested consumption is at zero.

In accordance with an example embodiment of the present invention, the method provides modeling the consumer whose behavior, i.e., whose consumption behavior, is to be checked, at least one dynamic model being used. In one embodiment, multiple consumers are modeled and checked. In the process, the consumption and the state, i.e., stationary or in transition, of each consumer are calculated. The states of the consumers are used to estimate the end of the transition. In the process, multiple groups of consumers may be modified simultaneously or consecutively, i.e., for example be degraded or deactivated.

Furthermore, input signals for the change or degradation, and the power of one or multiple consumers, together with the response time of the consumer or consumers, may be used to calculate the delayed power consumption of the consumer after a change in the degradation or power requests.

The described algorithms used in the method in accordance with an example embodiment of the present invention are addressed hereafter:

In the case of the maximum algorithm, it is provided that the calculated consumption of all consumers is compared to the measured consumption. Within a degraded operating state, a certain power consumption should not be exceeded in the error-free state. When the vehicle electrical system, in addition to the modeled consumers, also includes such consumers which cannot be dynamically modeled since, e.g., degradation and/or power requests are not known, these consumers are not modeled dynamically, but statically, in the model using their maximal power consumption. A tolerance threshold value may be added to the model to compensate for modeling inaccuracies and the measuring error.

In the case of the provided average algorithm, the calculated consumption of all consumers is compared to the average consumption. When the vehicle electrical system, in addition to the modeled consumers, also includes such consumers which cannot be dynamically modeled since, e.g., degradation and/or power requests are not known, these consumers are not modeled dynamically, but statically, in the model using their maximal power consumption. A tolerance threshold value may be added to the model to compensate for the deviations between the model and the measuring values.

In the case of the delta algorithm, the dynamic model of the consumers/the consumer is used to calculate a difference in the consumption after the degradation/deactivation process. The calculated difference is compared to the measured difference. Only one consumer or multiple consumers may participate during the transition when the degradation or deactivation or power request(s) arrive(s) at the same time at multiple consumers, or when the new degradation or deactivation request or a power request occurs before the last consumer has completed its own transition. In this case, the check of the transition of multiple consumers is carried out at the end of the transition of the last consumer.

In the case of the differential algorithm, the consumption during the transition is monitored.

In the case of the differential algorithm, furthermore the consumption change rate during the transition is monitored and, if necessary, evaluated after completion of the transition.

During the degradation or deactivation request or the request for less power, the consumption change rate dP/dt should be negative or zero in the case of normally functioning consumers, or should be below a certain tolerance, zero or positive to compensate for errors in the model and/or during measurements. One option for verifying the above conditions is to form the integral

$${\int }_{Transition start}^{Transition end} \vert \frac{d P ( t )}{dt} \vert d t ,$$

P(t) describing the power curve and t describing the time. Instead of the power curve P(t), it is also possible to use the current curve I(t). When this integral is smaller than or equal to the tolerances, plus the power change request or current change request, the consumer(s) is/are regarded as functioning, otherwise the consumer(s) is/are regarded as defective. The integral may also be implemented in a time-discrete manner.

One or multiple consumer(s) may participate in the transition when the degradation or deactivation or power request(s) arrive(s) at the same time for multiple consumers, or when the new degradation or deactivation or power request(s) occur(s) before the last consumer has completed its own transition. In this case, the end of the entire transition is considered to be the end of the last transition of a consumer that is included in the transition of the multiple consumers.

It furthermore may be important that, in particular in connection with the described differential algorithms, measurements are used which are carried out prior to the request, after the request, and during the request.

In the case of the inverse delta algorithm, the calculated consumption of the consumers is used to calculate a difference in the consumption before and after the restoration/switch-on transition, and the calculated difference is compared to the measured difference. One or multiple consumer(s) may participate during the transition when the degradation or deactivation or power request(s) arrive(s) at the same time for multiple consumers, or when the new restoration/switch-on or power request(s) occur(s) before the last consumer has completed its own transition. In this case, the end of the entire transition is considered to be the end of the last transition of a consumer that is included in the transition of the multiple consumers. Changes from the delta algorithm also have to be transferred in the inverse delta algorithm.

In the case of the minimum algorithm, the consumption is compared to a minimal threshold value. The threshold value could be statically (a constant) or dynamically calculated by the power models of the consumer. Tolerances and unmodeled consumers, i.e., consumers for which degradation or power requests are not known, could be added to this threshold value as constants. When the consumption is below the threshold value, the conclusion is that something is wrong with the connection of the QM consumers to the wiring harness between the DC-DC converter and the voltage supply or with the consumer itself, and corresponding measures may be taken, for example that a driver warning is triggered or that further measures are taken.

In the case of the counter algorithm, when testing multiple consumers in one pass, the defective and/or good consumers of the pass are counted in counters for each consumer. The counters may be used to detect a defective or an intact device where multiple consumers are checked simultaneously.

As was described above, the consumption was derived from a measured parameter. In one embodiment of the described method in accordance with the present invention, at least one energy store is provided, which supplies at least one safety-relevant consumer, at least one electronic load distributor being provided, via which the consumer is activated and safeguarded. The energy store is connected to the load distributor, a DC-DC converter suppliable by a further energy store being connected to the electronic load distributor for an alternative supply of the safety-relevant consumer. At least one further consumer is supplied with power between the DC-DC converter and the electronic load distributor. At least one electrical parameter is detected at the DC-DC converter and/or at the electronic load distributor and/or at further consumers to ascertain an electrical consumption of the further consumer. The consumption of the further consumer is compared to a threshold value.

By detecting at least one electrical parameter at the DC-DC converter and/or at the electronic load distributor and/or at the further consumer to ascertain an electrical consumption of the further consumer, and by comparing the consumption of the further consumer to a limiting value, and taking measures when the limiting value is exceeded to reduce the consumption of the further consumer, in particular deactivating or degrading the consumer, it is possible to further enhance the reliability of the alternative power supply of the safety-relevant consumers. The power supply of the further consumer is deliberately selected in such a way that the safety relevant consumer may be sufficiently supplied with electrical power to be able to reliably carry out safety relevant maneuvers, such as for example dynamic load maneuvers, such as for example braking/steering maneuvers for the transition into a safe state.

In one advantageous refinement of the present invention, it is provided that the consumption of the further consumer is ascertained when an alternative supply of the safety-relevant consumer is to take place by the DC-DC converter, instead of or in addition to the energy store. This further increases the security of the power supply since the specific load conditions may deliberately be taken into consideration during the respective impending alternative supply points in time. With this, the accuracy of the ascertainment increases further.

In one advantageous refinement of the present invention, the parameter ascertained at the DC-DC converter and/or at the electronic load distributor and/or at the further consumer, in particular, the current and/or voltage, is conveyed to the electronic load distributor and/or an energy management system or a further control unit. The ascertainment of the consumption may take place in existing control units. In particular, the implementation in the electronic load distributor is advantageous since current present at the input, for example, which is needed in any case for the further consumption ascertainment of the further consumer, is already available there. A conveyance of this parameter is no longer necessary in this case.

In one embodiment of the present invention, the initiation of counter-measures, such as for example a transfer of the vehicle into a safe state and/or an activation of warnings and/or error entries, takes place when the electrical consumption of the further consumer ascertained again exceeds the permissible limiting value. In this way, critical driving situations may be suppressed by timely counter-measures.

In one embodiment of the present invention, at least one load distributor is situated between the DC-DC converter and the electronic load distributor, via which the further consumer, and if necessary additional further consumers, is/are supplied with electrical power and, if necessary, is/are safeguarded, the consumption of the further consumers supplied via the load distributor being ascertained. In this way, it is ensured that all further consumers impairing the power supply of the safety-relevant consumer are taken into consideration.

In one advantageous refinement of the present invention, the state of the DC-DC converter and/or of a further energy store is ascertained, and a counter-measure, such as for example an error indication or a transfer into a safe state of the vehicle, is initiated in the case of an erroneous state. The safety of the system improves further since the operating state of further components may also be taken into consideration in a timely manner for possible counter-measures.

In one advantageous refinement of the present invention, the detected electrical parameter is conveyed via a communication means (a communication device), such as for example a bus system or a gateway, in particular, to the electronic load distributor and/or the energy management system. Such communication means are available in any case for the activation of the consumers, and may also be used for the shut-off or degradation.

The described system in accordance with the present invention is used to carry out the method and is, for example, implemented in hardware and/or software. The system may be integrated into or designed as a control unit of the motor vehicle.

Further advantages and embodiments of the present invention are derived from the description and the figures.

It shall be understood that the above-mentioned features and those still to be described hereafter may be used not only in the particular described combination, but also in other combinations, or alone, without departing from the scope of the present invention.

### BRIEF DESCRIPTION OF THE DRAWINGS

FIG. 1 shows a design of a vehicle electrical system for carrying out the method in accordance with an example embodiment of the present invention.

FIG. 2 shows one further embodiment of a vehicle electrical system, in accordance with the present invention.

FIG. 3 shows a consumption model of the maximum algorithm, in accordance with an example embodiment of the present invention.

FIG. 4 shows a consumption model of the average algorithm, in accordance with an example embodiment of the present invention.

FIG. 5 shows a model of the delta algorithm, in accordance with an example embodiment of the present invention.

FIG. 6 shows the differential algorithm, in accordance with an example embodiment of the present invention.

### DETAILED DESCRIPTION OF EXAMPLE EMBODIMENTS

The present invention is schematically shown in the figures based on specific embodiments and is described in greater detail hereafter with reference to the figures.

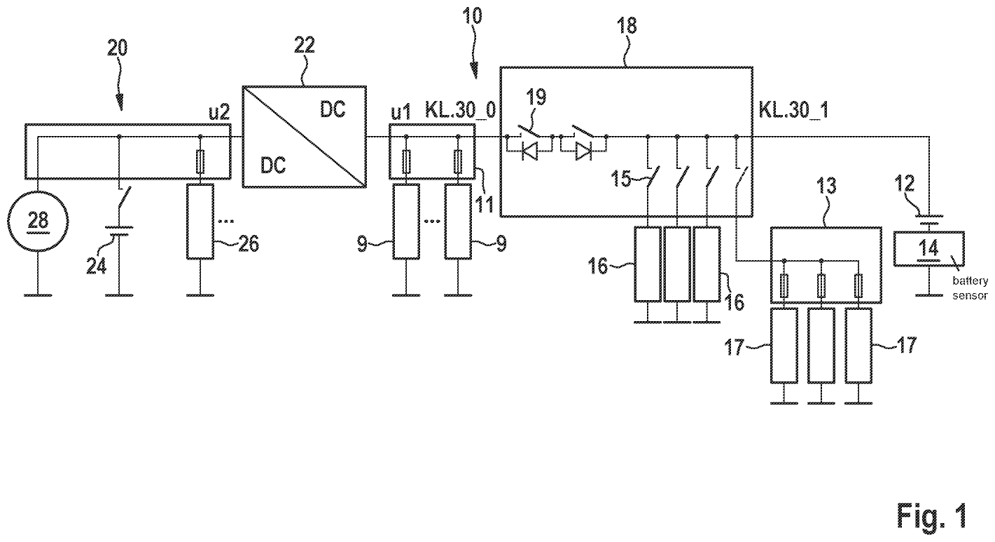

FIG. 1 shows a possible topology of a power supply system, made up of a base vehicle electrical system 10, which includes an energy store 12, in particular, a battery 12 including an associated battery sensor 14, as well as multiple consumers 16, which may be safeguarded or activated by an electronic load distributor 18. Energy store 12 is also connected to electronic load distributor 18. Electronic load distributor 18 includes multiple switching means (switches) 15, which each activate or safeguard, in particular, safety-relevant consumers 16. Switching means 15 could be semiconductor switches which act as electronic fuses, for example according to certain criteria, such as (over)voltage, (over)current, temperature, etc., and disconnect the particular safeguarded consumer 16 from the power supply in the event of impermissible operating states. Switching means 15 are in each case connected in parallel in the process. A further load distributor 13 is, for example, connected to a further switching means 15 of electronic load distributor 18, via which further consumers 17 are safeguarded (for example via safety fuses) and deliberately supplied with power. Consumers 17 may, for example, be lighting, windshield wipers or consumers 17 which, for example, are used after a crash. Electronic load distributor 18 furthermore includes a separating agent 19. Separating agent 19 may, for example, be a semiconductor switch, preferably two serial semiconductor switches including diodes situated antiparallel to one another. Separating agent 19 is used to disconnect electronic load distributor 18 from vehicle electrical subsystem 20, for example in the event of an error.

Electronic load distributor 18 is able to ascertain corresponding parameters such as voltage Uv, current Iv of consumers 16. Electronic load distributor 18 is furthermore also able to ascertain corresponding parameters of energy store 12 such as voltage Ub and/or current Ib and/or temperature Tb. For this purpose, electronic load distributor 18 includes the corresponding sensor system. Electronic load distributor 18 also includes corresponding processing means for storing or evaluating detected variables. As an alternative, the evaluation could also take place in another control unit. Electronic load distributor 18 may also detect the current or voltage present at the input (at the so-called terminal 30_0).

Electronic load distributor 18 is furthermore able to supply signals as a function of the state of energy store 12, based on which the transition into a safe state is initiated. For example, a higher-level control unit then, for example, initiates a safe stop of the vehicle (driving to the next parking lot, immediately stopping at the shoulder, etc.) and leaves the autonomous driving mode.

Consumers 16 activated by electronic load distributor 18 could, for example, encompass safety-relevant vehicle functions, such as for example braking, steering, etc. Safety-relevant consumers 16 could, for example, also cover important functions in a function-redundant manner.

Electronic load distributor 18 is electrically conductively connected to a further load distributor 11 on the side situated furthest from energy store 12. Further load distributor 11 is used to activate or safeguard further consumers 9. Further load distributor 11 is connected to a DC-DC converter 22. DC-DC converter 22 is used for the voltage conversion between a first base vehicle electrical system 10, which supplies consumers 9, 16, 17 with a voltage level U1 and a voltage level U2 of a further vehicle electrical system 20. Base vehicle electrical system 10 has a lower voltage level U1 compared to a high-voltage vehicle electrical system 20, for example, it may be a 12-V vehicle electrical system. The high-voltage vehicle electrical system 20 includes, for example, an energy store 24, for example a high-voltage battery, possibly including an integrated battery management system, a load 26 shown by way of example, for example a comfort consumer, such as an air conditioning system supplied with an elevated voltage level, etc., as well as an electric machine 28. High-voltage in this connection shall be understood to mean a voltage level U2 which is higher than voltage level U1 of base vehicle electrical system 10. It could, for example, be a 48-volt vehicle electrical system. As an alternative, it may be an even higher voltage level, particularly in the case of vehicles including a purely electric drive.

At least one or further, in particular, safety relevant channel(s) may be connected to base vehicle electrical system 10. The safety-relevant channels could in each case be connected via a further electronic load distributor to base vehicle electrical system 10. The further electronic load distributor could be used for safeguarding, activation, as well as the safe and reliable shut-off of safety-relevant consumers or of the electronic power supply network distribution. These consumers could be supplied in a function-redundant manner by different safety relevant channels. Moreover, the further electronic load distributor may be able to detect the flowing consumer currents or applied voltages. This briefly described but not shown embodiment could be provided for a highly available design, for example for autonomous driving to increase safety.

In the exemplary embodiment, a battery or rechargeable battery is described as a possible energy store 12, 24 by way of example. As an alternative, however, other energy stores suitable for this task may likewise be used, for example inductively or capacitively based, fuel cells, capacitors or the like.

In particular, the topology according to FIG. 1 may be used for implementing a safety-relevant vehicle electrical system for manual driving. In the process, a redundant power supply of safety-relevant consumers 16 both from energy store 12 and via the so-called terminal 30_0 (input of electronic load distributor 18 or output of DC-DC converter 22 on the low-voltage vehicle electrical system side), as well by DC-DC converter 22, supplied by further energy store 24, may take place. The redundancy from the supply via the so-called terminal 30_0 may only be ensured in the process when the consumer power at terminal 30_0 of further consumers 9 is below a certain threshold. Otherwise, the supply of terminal 30_0 or terminal 30_1 loads from DC-DC converter 22, if necessary including dynamic load maneuvers (braking/steering maneuver for the transfer into the safe state in the automated driving mode), cannot be implemented, and an impermissible voltage drop would occur, which could result in the loss of function of safety-relevant consumers 16 (steering, brake, etc.).

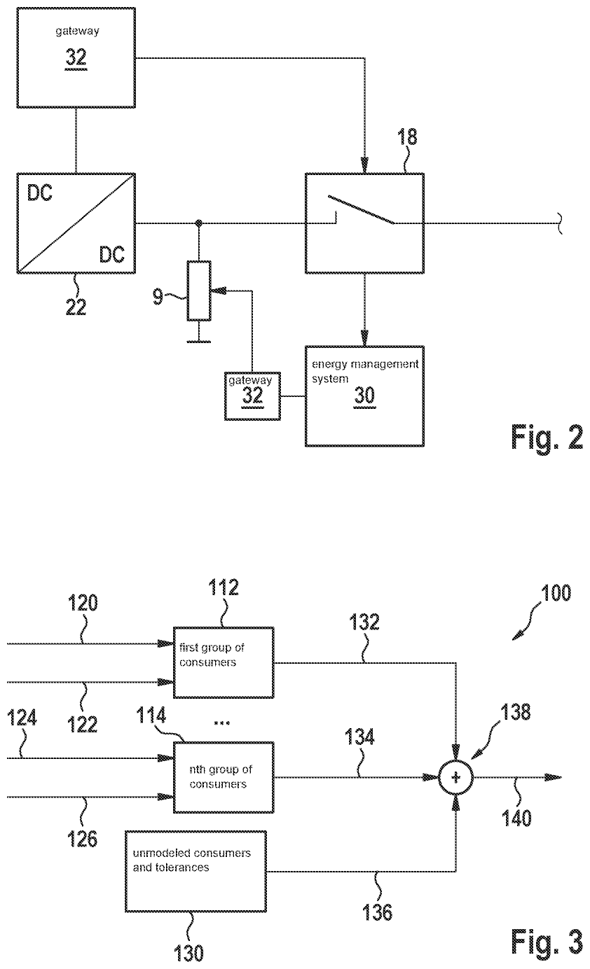

Methods described hereafter may counteract the problematic case just described. For example, a corresponding parameter, such as for example the current or the like, is detected or measured at DC-DC converter 22. The ascertained parameter is, for example, conveyed with the aid of a bus system or communication means (CAN bus, conveyance via a gateway 32 of the like) to electronic load distributor 18. A corresponding design is shown in FIG. 2 by way of example. There, DC-DC converter 22 is coupled via a gateway 32 to electronic load distributor 18. In addition, the current flowing at the input of electronic load distributors 18 or another suitable parameter is ascertained for ascertaining the consumption of further consumers 9.

In this way, the electrical consumption or the loading of consumers 9 supplied by load distributor 11 is ascertained. The consumption-characteristic parameter may be the current consumption or the corresponding power. The ascertainment of the current consumption, for example, takes place using the node rule, as a function of the current at DC-DC converter 22 and the current at the master switch or input of electronic load distributor 18. In this way, the consumer current by further consumers 9 may be ascertained. This ascertainment of the electrical consumption/power takes place, for example, in electronic load distributor 18, to which, as was already described, the measured current at the output of DC-DC converter 22 was conveyed. As an alternative, the ascertainment of the consumption of consumers 9 could also take place in another electronic component, such as DC-DC converter 22, a further control unit, or in a control unit for energy management system 30. As an alternative, the parameter could also be directly ascertained at further consumer 9. Thereafter, the current consumption of further consumers 9 is compared to a limiting value. When the current consumption of further consumers 9 exceeds this limiting value, the current consumption is too high, so that a sufficient supply of safety-relevant consumers 16 could not take place. In this case, a degradation or shut-off of consumers 9, or of at least one of consumers 9, is initiated. This could be initiated by electronic load distributor 18, for example.

As an alternative, an energy management system 30 could initiate the consumer degradation or consumer shut-off of further consumer 9 or of further consumers 9. Those are consumers 9 which are not needed for safety relevant functions. Using appropriate communication means, as indicated in FIG. 2 (for example a bus system, for example a CAN bus or via gateway 32), energy management system 30 sends requests for the shut-off or degradation to the particular consumers 9. The corresponding consumers 9 implement the shut-off or degradation after the signal has been received from energy management system 30.

Thereafter, it is checked whether a shut-off or degradation of consumers 9 has taken place or resulted in a corresponding consumption reduction. For this purpose, as was already described, both the parameter at DC-DC converter 22 and at the input of electronic load distributor 18 is detected, and the consumption value (for example current consumption) of further consumers 9, which are supplied via load distributor 11, is ascertained therefrom. The ascertained current consumption should now be below the permissible current or limiting value. Should this still not be the case, an emergency measure is initiated. This could, for example, be a transfer of the motor vehicle into a safe state, which, for example, is triggered by electronic load distributor 18 or another electronic device.

The described method is used to check the degradation or shut-off ability of consumers 9. In the process, for example during operation or during the vehicle start-up, consumers 9 are consecutively sent a signal for degradation or shut-off. By comparing the DC/DC converter current to the current at the master switch or separating agent 19 of electronic load distributor 18, it is now possible, before and after the signal for degradation or shut-off, to ascertain the current of consumers 9, and to check the function of the degradation or shut-off measure. This is necessary to be able to ensure that the supply of safety-relevant consumers 16 from terminal 30_0 may be ensured. One example would be, for example, the need of the degradation or shut-off of consumers 9 in the event of an insufficient supply of safety-relevant consumers 16 from energy store 12.

Using further measures, it could be ensured that the alternative power supply of safety-relevant consumers 16 via DC-DC converter 22, supplied by high-voltage vehicle electrical system 20, is sufficiently ensured. For example, the performance capability or the performance capability forecast of DC-DC converter 22 could be ascertained. As an alternative, the performance capability monitoring or performance capability forecast of DC-DC converter 22 in connection with high-voltage vehicle electrical system 20, and energy stores 24 included therein could be ascertained. As an alternative, a wiring harness diagnosis of the wiring harness situated between DC-DC converter 22 and electronic load distributor 11 could also be carried out. If indications of an improper operation of at least one of the monitored components could exist in the process, a transfer into a safe operating state could be initiated. Otherwise, the power supply of safety-relevant consumers 16 may now be covered from further vehicle electrical system 20.

Further measures in the event of an improper operation would also be possible, for example the setting or activation of a warning light and/or an error message and/or an error entry. Graduated warnings, depending on the severity of an error, would also be possible. For example, in the event that a degradation or a shut-off would not be sufficient, a certain warning (for example a yellow warning light) could be activated for a corresponding number of consumers 9. In the event that a degradation or a shut-off for individual consumers 9 would not be possible, for example, only one entry could be made to an error memory, which could be processed during the next stay in a repair shop, for example. As an alternative, the driver could also be warned (red warning light) in the event of the shut-off of certain consumers 9, while still providing the option of stopping or parking the vehicle within the scope of a worst-case maneuver.

In addition to the detected power, other physical variables could also be detected and evaluated, such as for example corresponding currents, temperatures or the like, at DC-DC converter 22 and/or at electronic load distributor 18.

The method is, in particular, suitable for ensuring the power supply of safety-relevant consumers 16 in a motor vehicle which implement functions of the automated driving operation. The use, however, is not limited thereto.

The following figures show, for illustration, the algorithms for monitoring the degradation of consumers used in the introduced method, which are also referred to as Monitoring of Consumers Degradation (MCD) algorithms.

FIG. 3 shows the consumption model of the so-called maximum algorithm (max algorithm) 100. Maximum algorithm 100 checks whether the consumption of a consumer, in particular, of a QM consumer, is below the modeled consumption. If this is not the case, a warning or warning message is triggered.

The illustration shows a first group of consumers 112 and an nth group of consumers 114. A power request 120 and a degradation request 122 are received by first group of consumers 112. A power request 124 and a degradation request 126 are received by the nth group 114. Furthermore, there is a block 130 which reflects unmodeled consumers and tolerances. This results in a consumption 132 of the first group of consumers 112, a consumption 134 of the nth group of consumers 114, and an unmodeled consumption 136. These are added (reference numeral 138) so that a maximal consumption 140 is modeled.

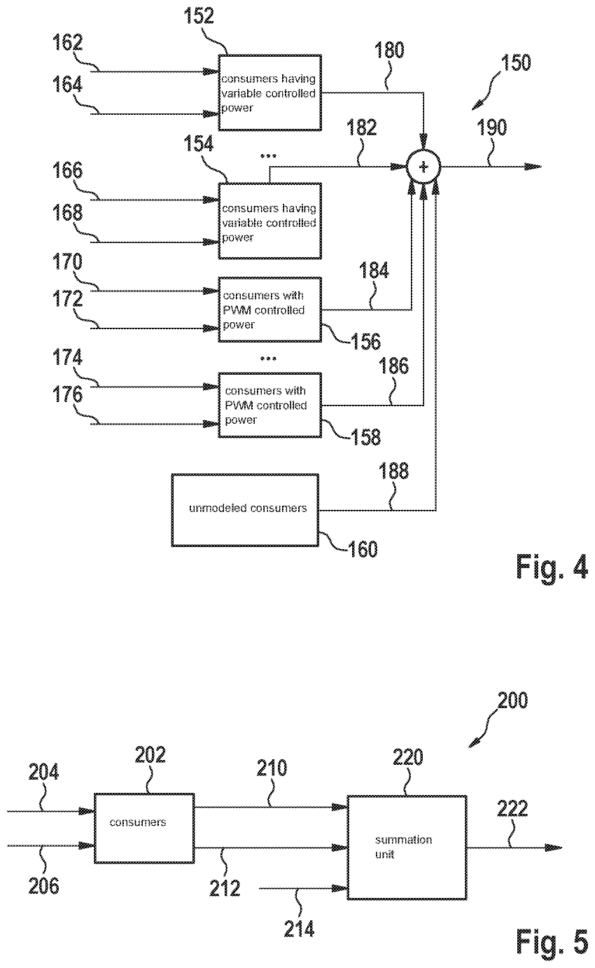

FIG. 4 shows the consumption model of average algorithm 150. This consumption model models the average consumption of a consumer and, in the process, calculates the allowed average consumption.

The illustration shows n groups of consumers having variable power 152, 154, and m groups of consumers having PWM controlled power 156, 158 and unmodeled consumers 160. A power request 162 and a degradation request 164 are received by the first group of consumers having variable power 152. A power request 166 and a degradation request 168 are received by the nth group of consumers having variable power 154. A power request 170 and a degradation request 172 are received by the first group of consumers having PWM controlled power 156. A power request 174 and a degradation request 176 are received by the mth group of consumers having PWM controlled power 158. A consumption 180 of the first group of consumers having variable power 152, a consumption 182 of the nth group of consumers having variable power 154, a consumption 184 of the first group of consumers having PWM controlled power 156, a consumption 186 of the mth group of consumers having PWM controlled power 158, and a consumption 188 of unmodeled consumers 160 are added to one another, and a consumption 190 is modeled.

The QM average consumption is calculated as a simple moving average, or SMA, of the QM consumption for the period of the PWM consumer. If there are PWM groups having different periods, the average for the least common multiple of the periods of the groups is determined.

The model of the average consumption, which is utilized in average consumption algorithm 150, is thus made up of n groups of consumers having variable power 152, 154, m groups of consumers having PWM controlled power 156, 158, and a parameter of consumption 188, which represents the maximal power or energy consumption of the unmodeled consumer. In this algorithm, the groups which model the consumer(s) not only consider the response times of the consumer, but also the lag of the simple moving average.

The average consumption thus measured must be smaller than, or smaller than or equal to, the modeled consumption. If this is not satisfied, one or multiple consumer(s) is/are discovered which has/have an increased power consumption and/or has/have not satisfied its/their degradation request. In this case, corresponding measures may be taken, for example a driver warning may be triggered or other measures may be taken.

Furthermore, the minimum algorithm (min algorithm) is introduced. The model is similar to the model of the maximum algorithm. However, the model of the minimum algorithm does not model the maximum, but the minimum power of the consumer. The algorithm checks whether the consumption of the consumer, in particular, QM consumer, exceeds the modeled minimal consumption. If this is not the case, a warning is triggered.

The basics behind this algorithm are that the QM consumption should not drop below a minimal consumption level during the driving cycle. If the consumption drops below this level, a problem exists with cables, connectors and/or QM consumers themselves.

FIG. 5 shows the model of delta algorithm 200. This algorithm, during each degradation or shut-off request, monitors whether the requested consumption savings have been implemented. The consumption prior to and after the degradation request is measured. A difference between the consumption prior to and after the degradation request is calculated from the measurement. From the model of the consumer, the consumption prior to and after the degradation request is calculated, and a difference is formed. Measured and modeled differences are compared, the following applying in the case of error-free consumers:

difference measured>difference modeled−tolerances

or

difference measured≥difference modeled−tolerances

The representation shows a group of consumers 202 which receive a power request 204 and a degradation request 206. From group 202, a power 210 prior to the degradation (power_before) and a power 212 after the degradation (power_after) are received by a summation unit 220, which calculates a modeled difference from the described variables. Tolerance 214 is subtracted from this difference in summation unit 220, and modeled difference (delta_modeled) 222 is output.

The powers of multiple groups of consumers can be supplied to summation unit 220. Only one group of consumers is shown in FIG. 5 for the sake of simplicity of the representation.

This delta 222 is calculated as follows:

delta_modeled=power_before−power_after−tolerance

or

delta_modeled=sum(power_before)−sum(power_after)−sum(tolerance) when multiple groups of consumers are modeled in the model.

Check: delta_modeled≤delta_measured

or delta_modeled<delta_measured

When the check fails, a warning is triggered by the algorithm. If multiple groups go into the transition simultaneously or consecutively before the first group has completed its transition, the variable power_before is determined at a point in time before the first transition for all groups, and the variable power_after is determined at a point in time when all groups have completed their transition.

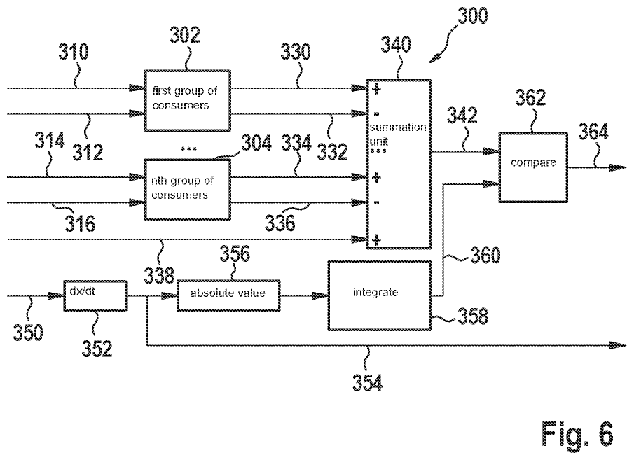

FIG. 6 shows a differential algorithm 300. The illustration shows a first group of consumers 302 and an nth group of consumers 304. A power request 310 and a degradation request 312 are received by first group of consumers 302. A power request 314 and a degradation request 316 are received by the nth group 304.

A consumption 330 of first group 302 before and a consumption 332 of first group 112 after, as well as a consumption 334 of nth group 304 before and a consumption 336 of nth group 304 after, as well as a tolerance 338 are received by a summation unit 340, and are added or subtracted there, depending on the sign. This results in the degradation request, together with tolerance 342.

A measured consumption 350, for example a current of a QM consumer, is derived, namely dx/dt 352, yielding derivative 354 of the consumption. An absolute value is then formed (reference numeral 356), which is integrated (reference numeral 358) from the beginning to the end of the transition. Result 360 of this integration is compared (reference numeral 362) to added value 342. When the result of integration 360 is smaller than, or smaller than or equal to, the degradation request, together with tolerance 342, the consumer(s) function(s) normally, otherwise in an erroneous manner. This yields a result 364.

Result 364 shows the state of the consumers from the last check, normal or erroneous. 354 shows the power change rage dP/dt.

The differential algorithm monitors the degradation behavior during the transition, and evaluates it qualitatively. The algorithm detects positive consumption change rates, and classifies the consumer degradability as erroneous when positive consumption change rates more than what is permitted by the tolerance are detected.

This is carried out by making the following assumption during the transition:

$${\int }_{Transition start}^{Transition end} \vert \frac{d P}{d t} \vert dt \leq degradation request + tolerance \qquad ( equation 1 )$$

The differential algorithm monitors the degradation transition and may discover reset failures in consumers which cannot be discovered by the other MCD algorithms.

When a degradation fails in the case of the maximum algorithm, a warning is displayed by the MCD. In this case, a second check may be carried out with the differential output. When the differential output is negative, below a small, negative threshold value, the defective QM device attempts to carry out the degradation, and potentially does so successfully, but more slowly than expected. Thus, when the maximum algorithm fails, and the differential output exceeds the small negative threshold value, a second warning or DTC may be displayed by the MCD, which shows that the defective QM device does not even attempt to degrade.

What is claimed is:

1. A method for checking a behavior of at least one group of consumers in a motor vehicle, the method comprising:
checking whether the at least one group of consumers behaves corresponding to a request to change its consumption, the checking including:
measuring a power consumption of the at least one group of consumers; and
comparing the measured power consumption to a modeled consumption calculated based on a dynamic model of the at least one group of consumers, at least one algorithm being used for the comparison.

2. The method as recited in claim 1, wherein a parameter of the at least one group of consumers is measured, which represents the consumption of the at least one group of consumers, and the parameter is compared to a threshold value.

3. The method as recited in claim 1, wherein, within a scope of the check of a degradation, at least one algorithm is used, which is selected from a group encompassing a maximum algorithm, an average algorithm, a minimum algorithm, a delta algorithm, an inverse delta algorithm, a differential algorithm.

4. The method as recited in claim 3, wherein all algorithms run simultaneously within the scope of the check.

5. The method as recited in claim 3, wherein measuring results ascertained during a transition are used.

6. The method as recited in claim 1, further comprising:
establishing prior to the request that an overall power consumption is too high.

7. The method as recited in claim 1, wherein a group of consumers in which an excessive power consumption is established is degraded.

8. The method as recited in claim 1, wherein the group of consumers, in which it is established that a power consumption savings after a degradation is less than a power consumption savings request, is degraded.

9. The method as recited in claim 1, wherein the group of consumers, in which it is established that the power consumption increase after a restoration or after a switch-on is smaller than a necessary power consumption increase request, is restored or switched on.

10. The method as recited in claim 1, wherein power of one or multiple groups of consumers is controlled by a switch-on and shut-off cycle, without it being necessary to know a state of the one or multiple groups of consumers. 158), an average consumption being calculated and used to estimate whether the group of consumers has carried out, without errors, a degradation or restoration or switch-on or shut-off request.

11. The method as recited in claim 1, wherein at least one energy store is provided, which supplies at least one safety-relevant consumer, at least one electronic load distributor being provided, via which the safety-relevant consumer is activated and safeguarded, the energy store being connected to the electronic load distributor, a DC-DC converter suppliable by a further energy store being connected to the electronic load distributor for an alternative supply of the safety-relevant consumer, and at least one further consumer being supplied with power between the DC-DC converter and the electronic load distributor, at least one electrical parameter being detected at the DC-DC converter and/or at the electronic load distributor and/or at consumers to ascertain an electrical consumption of the consumer, and the consumption of the consumer being compared to a limiting value and, when the limiting value is exceeded, measures being taken for reducing the consumption of the consumer.

12. A module for checking behavior of at least one group of consumers in a motor vehicle, the module configured to:
check whether the at least one group of consumers behaves corresponding to a request to change its consumption, for the check, the module configured to:
measure a power consumption of the at least one group of consumers; and
compare the measured power consumption to a modeled consumption calculated based on a dynamic model of the at least one group of consumers, at least one algorithm being used for the comparison.

13. The module as recited in claim 12, wherein the module is integrated into a control unit of the motor vehicle.
